(19) United States
(12) Patent Application Publication
(10) Pub. No.: US 2026/0212432 A1
(43) Pub. Date: Jul. 23, 2026

(54) CONSTRUCTION MANAGEMENT SYSTEM, CONSTRUCTION MANAGEMENT METHOD, AND PROGRAM

(71) Applicant: NOHARA GROUP, INC., Tokyo (JP)

(72) Inventors: Takeshi MACHIDA, Tokyo (JP); Syun KATAYAMA, Tokyo (JP)

(21) Appl. No.: 19/134,964

(22) PCT Filed: Nov. 27, 2023
(86) PCT No.: PCT/JP2023/042310

§ 371 Date: Jul. 1, 2025

(30) Foreign Application Priority Data
Dec. 2, 2022 (JP) 2022-193323

(51) Int. Cl. G06Q 50/08; G06Q 10/0631; G06Q 10/0875; G06Q 10/10

(52) U.S. Cl. CPC G06Q 50/08; G06Q 10/06312; G06Q 10/0875; G06Q 10/103

(57) ABSTRACT

To provide a system for confirming information relating to building materials to be used in a building at an arbitrary stage of planning. A construction management system for managing a construction of a building, includes: a storage device storing management information in which information relating to a structure constituting a building and information relating to a building material constituting the structure are associated with each other; and an output unit for displaying information indicating the information relating to the building material, for each the structure, according to the management information, in a construction management table of the building. In a case where a degree of detail of the information relating to the building material satisfies a predetermined condition, the output unit displays a representation which is different from a case where the predetermined condition is not satisfied, with respect to the information indicating the information relating to the building material, in the construction management table.

### FIELD

### Relevant Applications

This application claims priority to Japanese Patent Application No. 2022-193323 filed on Dec. 2, 2022, entitled “CONSTRUCTION MANAGEMENT SYSTEM, CONSTRUCTION MANAGEMENT METHOD AND PROGRAM”, the content of which is incorporated herein by reference in the entirety.

The present invention relates to a construction management system, a construction management method, and a program thereof.

### BACKGROUND

As a background art of the present technical field, Japanese Patent Application Publication No. 2021-005264 (Patent Document 1) is cited. This document discloses that “there are BIM parts (or BIM components) which are capable of being incorporated into a BIM model for a housing equipment. When a computer executes a CAD program, the computer displays a three-dimensional shape of the BIM part on a display unit. And when the computer receives an input relating to attribute information of a housing equipment from the user through the input unit, the computer changes the three-dimensional shape to be displayed on the display unit, according to the inputted attribute information. The BIM part includes three-dimensional shape data for enabling the computer to display the three-dimensional shape on the display unit, and restriction data for enabling the computer to execute processing to restrict the change of the three-dimensional shape for combinations which are unacceptable with respect to the attribute information (see Abstract).”

### PRIOR ART DOCUMENTS

[Patent Document 1] Japanese Patent Application Publication No. 2021-005264

### SUMMARY

### Problem to be Solved by the Invention

According to the technology disclosed in the Patent Document 1, the combinations of facility equipment which are physically unacceptable at the designing stage of a building is restricted, and accordingly, it is said that it is possible to suppress the occurrence of rework from the facility planning stage to the designing stage. However, the Patent Document 1 does not discuss a system for confirming information relating to building materials to be used in a building at an arbitrary stage of planning.

Therefore, the present invention provides a system for confirming information relating to building materials to be used in a building at an arbitrary stage of planning.

### Means for Solving the Problem

In order to solve the above-mentioned problems, for example, the configurations described in the claims can be adopted.

Although the present application includes a plurality of means for solving the above-mentioned problems, for example, according to an embodiment, the below-mentioned construction management system is provided. The construction management system for managing a construction of a building, includes:
a storage device storing management information in which information relating to a structure(s) constituting a building and information relating to a building material(s) constituting the structure are associated with each other; and
an output unit for displaying information indicating the information relating to the building material(s), for each the structure, according to the management information, in a construction management table of the building.

In a case where a degree of detail of the information relating to the building material satisfies a predetermined condition, the output unit displays a representation which is different from a case where the predetermined condition is not satisfied, with respect to the information indicating the information relating to the building material, in the construction management table.

### Effects of the Invention

According to the present technology, it is possible to provide a system for confirming information relating to building materials to be used in a building at an arbitrary stage of planning.

Problems, constitutions, and effects other than those described above will be apparent from the following descriptions of embodiments.

### BRIEF DESCRIPTION OF THE DRAWINGS

FIG. 1 is an example of an overall configuration of a construction management system 100;

FIG. 2 is an example of a hardware configuration of a management server 101;

FIG. 3 is an example of a hardware configuration of a user terminal 102;

FIG. 4 is an example of project information 400;

FIG. 5 is an example of a diagram conceptually illustrating a configuration of management information 500;

FIG. 6 is an example of a construction management flow;

FIG. 7 is an example of a status determination flow;

FIG. 8 is an example of a finishing table screen 800;

FIG. 9 is an example of a component window 900;

FIG. 10 is an example of a detail/change screen 1000; and

FIG. 11 is an example of a material table screen 1100.

### DESCRIPTION OF THE PREFERRED EMBODIMENTS

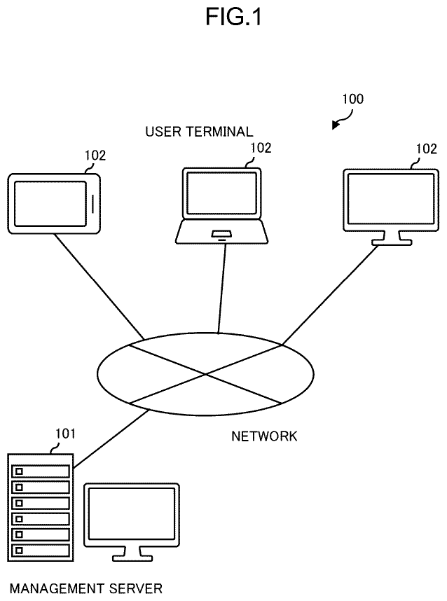

Hereinafter, a construction management system according to the present embodiment will be described with referring to the figures. For configuration elements having the same function, reference signs and duplicated explanation will be omitted

[Construction management system] FIG. 1 depicts an example of a configuration diagram of a construction management system 100 according to one embodiment. The construction management system 100 according to the present technology is a system which is capable of acquiring and managing detailed information used for structure design and facility design, according to data for producing drawings to be used in design planning, and capable of outputting the detailed information as a construction management table, for example, as a finishing table, at an arbitrary timing, during the course of the planning/designing of a building.

In the present embodiment, BIM (Building Information Modeling) data to be used in BIM technology is used as data for producing drawings. And the present technology will be described based on an embodiment example in which a finishing table and a material table are outputted, as one example of a construction management table of interior construction of a building.

As illustrated in FIG. 1, the construction management system 100 includes one or a plurality of management servers 101 and one or a plurality of user terminals 102. The management server 101 is one example of a construction management device according to the present technology. Each of one or a plurality of the user terminals 102 is respectively configured to be connectable to one or a plurality of management servers 101 through a network. The network can be wired or wireless, and the respective terminals are capable of sending and receiving information to and from each other through the network.

Each of the management server 101 and the user terminal 102 (hereinafter, simply referred to as “terminal”) to be used in the construction management system 100 may be, for example, a mobile terminal such as a smartphone, a tablet, a mobile phone, or a personal digital assistant (PDA), or a wearable terminal such as a glasses-type wearable terminal, a head-mounted-type wearable terminal, a wristwatch-type wearable terminal, or a clothing-type wearable terminal. Any of these devices may be a stationary-type computer or a portable-type computer, or a server to be disposed on a cloud or a network. From the perspective of the function, any of these devices may be a VR (Virtual Reality) terminal, an AR (Augmented Reality) terminal, or a MR (Mixed Reality) terminal. Alternatively, a combination of a plurality of terminals may be used for any of them. For example, a combination of one smartphone and one wearable terminal may logically function as one terminal. Other information processing terminals may be used.

Each of the terminals of the construction management system 100 includes a processor for executing an operating system, an application, a program, and the like; a main storage device such as a RAM (Random Access Memory); an auxiliary storage device such as an IC card, a hard disk drive, an SSD (Solid State Drive), or a flash memory; a communication control unit such as a network card, a wireless communication module, or a mobile communication module; an input device such as a touch panel, a keyboard, a mouse, or a voice input device: and an output device such as a monitor, a display, a printer, a voice output device, or an oscillator. The input device may be an input device functioning based on motion detection in which images are obtained by a camera, an input device functioning based on character detection in which images are obtained by a camera, or an input device functioning based on a position sensor (for example a GPS), a gyrosensor, an accelerometer, or a thermal sensor. The output device may be a device or a terminal for transmitting information in order to output it to an external monitor, a display, a printer, a device, or the like.

The main storage device is capable of storing various programs, applications, and the like (software modules) therein, and when a processor executes any of these programs and applications, each functional element of the entire system is realized. Each module may be an independent program or application, or each module may be implemented in a form of a subprogram or a function as a part of a single integrated program or application. In addition, each module may be realized by combining a plurality of independent programs. Each module may be implemented as a hardware (hardware module), such as by integrating a circuit or employing a microcomputer. Furthermore, each module may be provided in a single terminal, or may be provided separately in two or more terminals which are connected to each other via a network. It is also conceivable that a part of modules may be installed in a country different from a country where the other modules are installed.

In the present specification, each module is described as a main part (subject) for executing processing, but in practice, a processor for executing various programs, applications, and the like executes processing.

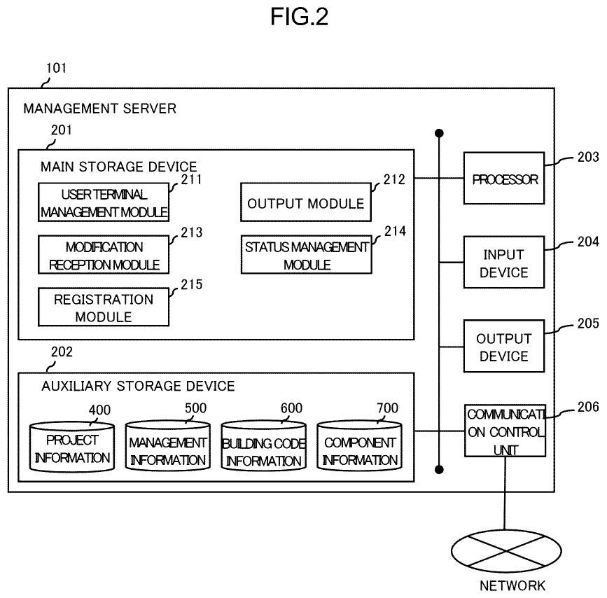

The auxiliary storage device is capable of storing various databases (DB) therein. A “database” means a collection of data which is collected and organized in order to cope with arbitrary data manipulation (for example, extraction, addition, deletion, overwrite, etc.) which is executed by a processor or an external computer. The auxiliary storage device is a functional element (storage device) capable of storing one or a plurality of data sets. The database may be implemented by a database management system, a spreadsheet software, or a text file such as XML, JSON, but the implementation method of the database is not limited to these examples.

[Management server] FIG. 2 depicts an example of a hardware configuration of the management server 101.

Typically, the management server 101 is a terminal to be used by an administrator who manages and operates the construction management system 100.

According to the present embodiment, the management server 101 is a configuration element capable of managing the construction management system 100. For example, the management server 101 is constituted by a server which is arranged on a cloud. The management server 101 includes a main storage device 201 and an auxiliary storage device 202. The management server 101 also includes a processor 203, an input device 204, an output device 205, and a communication control unit 206, as described above.

The main storage device 201 stores programs and applications such as a user terminal management module 211, an output module 212, a change reception module 213, a status management module 214, and a registration module 215. The respective functional elements of the management server 101 are realized when the processor 203 executes these programs and/or applications stored in the main storage device 201.

The auxiliary storage device 202 stores information necessary for operations of the construction management system 100. The auxiliary storage device 202 stores, for example, project information 400, management information 500, building code information 600, component information 700, and the like. Details of these pieces of information will be described later.

Subsequently, the respective functional elements of the management server 101 will be briefly described. Specific operations of the respective functional elements will be described later.

The user terminal management module 211 manages operations of the user terminal 102. The user terminal management module 211 cooperates with the user execution module 311 of the user terminal 102 so as to control basic operations for utilizing the construction management system 100 at the side of the user terminal 102.

For example, the user terminal management module 211 cooperates with the user execution module 311 so as to output (or display), to the output device 305 (for example, a display or the like) of the user terminal 102, a login page, a project management page or the like for accessing a project management site (hereinafter, simply referred to an “application”) which is provided on the web by the management server 101. In addition, for example, the user terminal management module 211 cooperates with the user execution module 311 so as to acquire input information which is inputted from the user terminal 102 through the pages. For example, the user terminal management module 211 is capable of operating, based on the acquired information (or various kinds of information, instructions, and the like), and capable of outputting (or storing) the acquired information to the auxiliary storage device 202, as management information 500 and the like.

The output module 212 is a configuration element for outputting (or displaying) a construction management table. The output module 212 cooperates with the user construction management module 312 of the user terminal 102 so as to output a construction management table to an output device 305 (for example, a display or the like) of the user terminal 102. In the construction management table, the output module 212 displays information relating to a building material for each structure constituting a building subject to construction (or a target building), based on the management information 500,

The change reception module 213 is a configuration element capable of receiving a change of/in a component which is constituting a building material. The building material is an element for constituting a structure which constitutes a target building, and typically, the building material constitutes a component which constitutes the above-mentioned structure.

The status management module 214 is a configuration element capable of managing information relating to a component(s) constituting a building material(s). For example, the status management module 214 creates management information by associating information relating to a structure(s) with information relating to a building material(s) constituting the structure. Typically, the status management module 214 manages a degree of detail of information associated with the building material.

The registration module 215 is a configuration element capable of assigning codes which have been prepared in advance, with respect to BIM data, in order to manage information relating to a component(s) of a building material(s). The codes are prepared so as to cope with information at one of several stages (or levels) which are needed in accordance with the progresses of the construction.

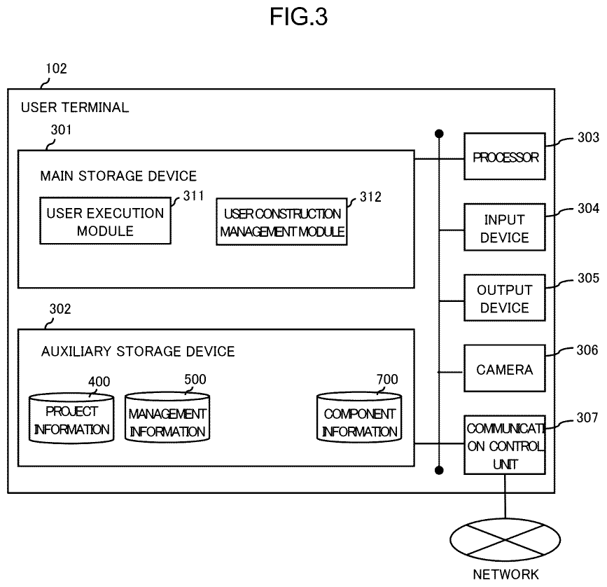

The auxiliary storage device 202 stores information necessary for the execution of the construction management system 100. The auxiliary storage device 202 stores, for example, project information 400, management information 500, building code information 600, component information 700, and the like. It is assumed that some or all of these pieces of information are stored in JSON format files, but not limited to this example. Some or all of these pieces of information may be stored in a relational database or a non-relational database.

[User terminal] FIG. 3 depicts an example of a hardware configuration of the user terminal 102. The user terminal 102 is a terminal to be operated by a user who uses the construction management system 100, and for example, the user terminal 102 is constituted by a terminal such as a smart phone, a tablet, a notebook PC, or a desktop PC. The user terminal 102 includes a main storage device 301 and an auxiliary storage device 302. In addition, the user terminal 102 includes a processor 303, an input device 304, an output device 305, a camera 306, and a communication control unit 307, as described above.

The main storage device 301 is capable of storing programs and applications such as a user execution module 311 and a user construction management module 312. When the processor 303 executes these programs and/or applications, the respective functional element of the user terminal 102 are realized.

The user execution module 311 controls basic operations of the user terminal 102 when the construction management system 100 is used. For example. the user execution module 311 cooperates with the user terminal management module 211 of the management server 101 so as to display management information at the side of the construction management system 100.

For example, the user execution module 311 is realized when the processor 303 executes a project management application (hereinafter, simply referred to an “application”) of the construction management system. The user execution module 311 cooperates with the user terminal management module 211 of the management server 101 so as to output (or display) a login page or the like of the project management site, to the output device 305 (for example, a display or the like) of the user terminal 102.

The user construction management module 312 is capable of receiving a change in the management information, on the project management site, from the user. For example, the user construction management module 312 cooperates with the change reception module 213 of the management server 101 so as to receive a change of a component constituting a building material, and to transmit the received information to the management server 101.

The auxiliary storage device 302 is capable of storing information necessary for operations of the user terminal 102. For example, the auxiliary storage device 302 stores project information 400, management information 500, component information 700, and the like. These pieces of information may be some or all of information relating to the user terminal 102, selected from among the project information 400, the management information 500, the component information 700, and the like stored in the management server 101.

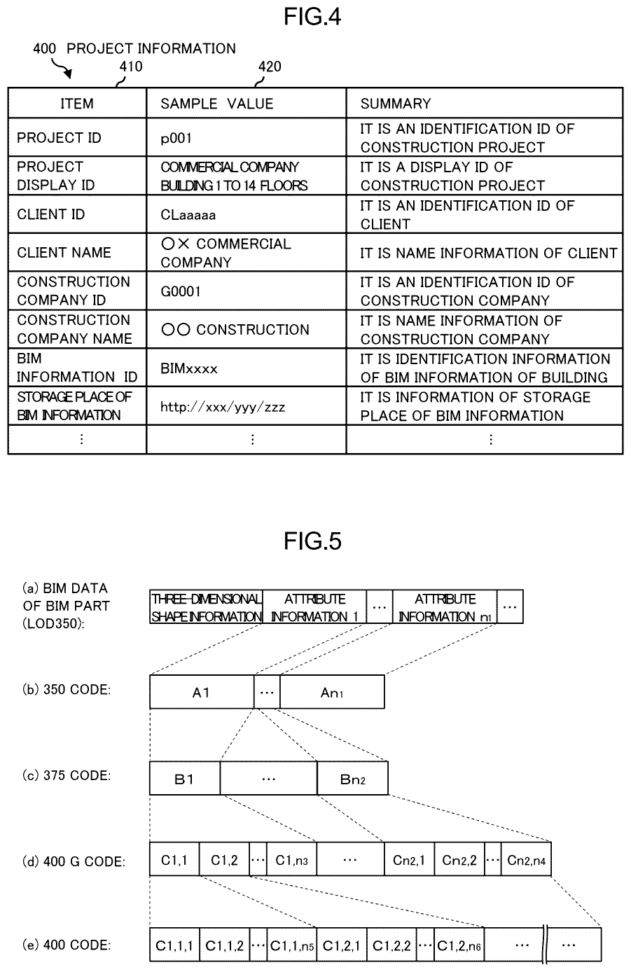

FIG. 4 depicts one example of the project information 400.

The project information 400 is information relating to a construction project or a building project (hereinafter, simply referred to a “project”) subject to management. For example, the project information 400 includes information such as a project ID, a project representation ID, a client name, a construction company ID, a construction company name, a BIM information ID, a storage place of BIM information, and the like, and values exemplified by the sample values 520 are inputted to the respective item names 510.

The project ID is a symbol to be assigned to each project in order to identify a project subject to management. For example, the project ID is automatically generated as a hash-value or the like. Basically, information relating to each projects is associated with the project ID. The project display ID is an ID for displaying a project to be displayed on a screen of the administration server 101 or the user terminal 102, etc., and the project display ID can be arbitrarily set. The client ID and the client name are information relating to the identification ID and the name of the client, respectively. The construction company ID and the construction company name are information relating to the identification ID and the name of the construction company, respectively. The BIM information ID and the storage place of BIM information are the ID for identifying BIM information about the target project and its storage place, respectively. However, the content of the project information is not limited to this example.

The management information 500 is information, associating information relating to a structure constituting a target building with information relating to a building material constituting the structure.

The structure is a configuration element constituting a building, and is a part in a state of being united in the building. For example, it is possible to recognize the structure as a system, a construction, or an assembly, etc., having a constitution in a state of being united as one part, in general. During the course of the management of planning (or designing) and of constructing the interior work according to the present embodiment, when a building is divided into spaces (typically, rooms or the like) which are set respectively in a state of being united, it may be defined as a relatively large unit such as a wall, a ceiling, a floor, or the like which is capable of partitioning spaces.

The building material is a configuration element for constituting a structure. According to the present embodiment, when the structure is made to be an interior wall, the building material may be recognized, for example, as a base material or a finishing material constituting the interior wall. The base material and the finishing material may further be composed of several building parts. For example, in the building material, a main component may be used in combination with other components necessary for adjustment with neighboring members or associated elements.

As described above, the structure and the building material have a certain relationship, and the information relating to the structure and the information relating to the building material are associated with each other in the management information 500. For example, the association of the management-information 500 may be performed manually at the stage of planning/designing or may be performed mechanically based on the BIM data. In another aspect, the BIM may be constructed in a more detailed manner based on the management-information 500.

Subsequently, the BUN will be briefly described.

The BIM is a system for constructing a three-dimensional building information model on a computer so as to be used for more successfully producing and managing the building.

The BIM model refers to a building information model which includes three-dimensional shape information to be created on a computer, and also attribute information of a building such as a name and an area of a room, or the like, a specification or performances of a material/component, finishing, and the like. For example, the BIM model of building is typically constructed as a collection of BIM parts such as the wall, floor, ceiling, column, fitting, equipment. Each structure according to the present embodiment may correspond to, for example, the BIM part. The BIM part may include information relating to the material(s) and assembly processes (for example, time), in addition to the shape information (geometric information) such as the shape, width, depth, height, position, and orientation.

The BIM data (BIM information) refers to entire information including two-dimensional, additional information or textual information on the BIM, in addition to the BIM model including the above-mentioned shape information and the attribute information.

Accordingly, by creating the BIM model using a BIM tool, it becomes possible to utilize the information which has been accumulated throughout the entire building life cycle from the planning/designing stage to the constructing stage and the maintaining stage. For example, the BIM part may be provided as a file (for example, RFA file) based on IFC data format (ISO16739: 2013) capable of being read into a BIM software. For example, the BIM part may be created in accordance with the target structure, or the BIM part may be provided in any of various BIM tools so that it can be used.

For implementation, at the planning/designing stage of a building, it is common to prepare drawings such as a rectangular gauge view, an exploded view, a ceiling-down view, a detailed plan view, and a detailed partial view as results, in addition to a general view of the building. At this time, in a case where the shape information, etc., of all the building members is made at the level of the detailed partial view, the data of the BIM model becomes too large and it may lose the operability of the BIM tools. For this reason, it is important to set the density and accuracy of the information of the BIM model to the required level, for example, at every planning stages.

For example, it is possible to set an index LOD (Level of Development) for indicating the detail of information of the shape information and the attribute information of the BIM model. It is possible to define the LOD at six steps of 100, 200, 300, 350, 400 and 500. However, the LOD is not necessarily defined according to the planning stage.

Accordingly, for example, when the planning stage is almost completed, BIM parts constituting a BIM model are set to have about LOD 350 in many cases, but setting various LODs to BIM parts is also acceptable. When shifting from the planning stage to the constructing stage, it is desirable to use the BIM information of about LOD 400 such that an order can be placed for the building materials or components. In an actual field, there are problems such that it is difficult or troublesome to concretely perform the shift from the stage of LOD 350 to the stage of LOD 400. As a result, it becomes difficult to acquire information necessary for the construction, and it is likely that the rework is required, and accordingly, the budget is rebuilt and the building materials are re-selected. This tendency can be quite significant in cases of interior construction in which wrinkling is likely to occur because the interior construction is performed as a post-process of the construction work.

The LOD350 and the LOD400 can be defined as follows.

That is, the LOD350 is defined as such: “Parts which are necessary for arranging adjacent or neighboring elements are modeled. These parts include a support member or a joining member, etc. It is possible to directly measure the quantity, size, form (or shape), position, and orientation of the designed/planned elements based on the model, without referring to unmodeled information such as notes and written dimensions.”

The LOD400 is defined as such: “Models/elements of LOD 400 are modeled with enough detail and accuracy for producing them. It is possible to directly measure the quantity, size, form/shape, position, and orientation of the designed/planned elements based on the model, without referring to unmodeled information such as notes and written dimensions.”

Accordingly, the present technology makes it possible to create a construction management table which is referred to, at an arbitrary timing, based on the management information, for smoothly proceeding the construction from the planning stage to the construction stage. The construction management table typically displays information indicating information relating to a building material(s) for each structure, and the construction management table can be used, for example, in interior construction, as a finishing table (also referred to a “specification table”) or a material table.

As another example of the construction management table, the present embodiment is also capable of displaying a material table for displaying information indicating information relating to a building material(s) and information relating to a space(s) in which the building material is used, in order to manage the degree of detail, for each structure, but it is not always necessary.

Hereinafter, the structure of the management information 500 will be described.

FIG. 5 depicts a diagram conceptually illustrating a constitution (that is data constitution) of the management information 500. In FIG. 5, the respective codes (which are represented as from (b) 350 code to (e) 400 code) refer to codes which are stored in the building code information 600.

As illustrated in FIG. 5, the (a) BIM data relating to the structure (in other words, BIM part) includes, for example, three-dimensional shape information and one or a plurality of pieces of attribute information. These three-dimensional shape information and one or a plurality of pieces of attribute information are associated with identification information (for example, file name of BIM data) of the structure.

The three-dimensional shape information may be information relating to the dimensions/sizes of the structure. In addition, the attribute information may be information relating to the constitution of the structure, and may include, for example, a space in which the structure is arranged, a part (position and orientation), a specification required for the structure, and information relating to the building material to be used. For example, in a case where the BIM part is an interior wall part, the attribute information may include, for example, information relating to the floor and the room (space) in which the interior wall is arranged and the positions thereof, information indicating that it relates to the interior wall (for example, the base material of the wall), a specification required for the interior wall, and information relating to the building material to be used for the interior wall.

For example, the registration module 215 acquires information relating to the dimensions of a building material(s) constituting the structure based on the three-dimensional shape information of the (a) BIM data. In addition, the registration module 215 acquires, for example, information relating to the floor (or story) or the name of room in which the structure is arranged, and information relating to the part, based on the attribute information of the (a) BIM data. The registration module 215 associates these pieces of information with the identification information of the structure and records them as the management information 500 in the auxiliary storage device 202.

In addition, the (a) BIM information may include attribute information relating to the specification, for example, may include information indicating that “it is an interior wall having two sheets of double-sided gypsum boards made of semi-incombustible and incombustible materials, as a finishing material, on a Light Gauge Steel (LGS) wall having a thickness of 65 mm as a base material”. In this case, for example, the information relating to the interior wall may be made to be the attribute information 1, the information relating to the LGS wall may be made to be the attribute information 2, the information relating to the finishing material may be made to be the attribute information 3, the information relating to the semi-incombustible gypsum board may be made to be the attribute information 4, and the information relating to the incombustible gypsum board may be made to be the attribute information 5. In this way, the (a) BIM data includes, for example, attribute information relating to the constitution of the structure, at least, and then the attribute information may include information relating to the building material constituting the structure.

The BIM data may have different expression forms according to the BIM tool or creator who creates it. And for that, the registration module 215 is capable of rewriting the respective pieces of attribute information, by using certain codes which are made common, but it is not always necessary. For example, the present technology makes the common codes to have four levels from (b) to (e) as illustrated in FIG. 5. The registration module 215 assigns an appropriate code from each of these four stages of codes, either directly or indirectly, to the BIM data. In FIG. 5, the dotted lines indicate a state in which the appropriate codes (b) to (e) are associated with the BIM data in a hierarchical manner.

The above-mentioned codes from (b) to (e) represent information relating to the building material in an array of one or a plurality of computer-readable symbols (which are concepts including characters/letters, numbers, and symbol characters). Each code is capable of being converted to a computer internal representation (or computer code) and capable of being encoded.

The (b) 350 code is a code corresponding to the attribute information included in the BIM data of about LOD 350. For example, the 350 cord may be provided to schematically represent a constitution of a building material. As one example, the registration module 215 is capable of associating the 350 codes of from A1 to An₁ with some or all of the attribute information 1 to n₁ relating to the above-mentioned constitution of the structure. Here, for example, n₁ may be a numerical value of the attribute-information to be used for creating the construction-management table.

More specifically, with respect to the attribute-information relating to the constitution of the structure, for example, in the case of the “LGS wall having two sheets of double-sided gypsum boards made of semi-incombustible and incombustible materials”, the registration module 215 may assign 350 codes such as: “1W” to the interior wall; “(L)” to the lightweight steel wall having a thickness of 65 mm; “A” to the wallpaper of the finishing material, and “E” to the two sheets of double-sided gypsum boards made of semi-incombustible and incombustible materials. These pieces of attribute information may be represented as a combination of these 350 codes, for example, as “IW_(L)EA0/EA0_109” and the like.

The 350 codes may include other information required for carrying out the construction and the determination of components, for example, information relating to a fitting of top end of the LGT wall (for example, “0” for the case where the position of top end is on a ceiling, and “1” for the case of slab), and information relating to layer thickness of the LGS wall (for example, wall thickness (units: mm) without wallpaper).

The (c) 375 code may be assigned to each of one or a plurality of building materials constituting the structure. Typically, the 375 code may be provided as a code for representing the kind of each building material (which may be the performance, specification, standard, and the like). Such a code is newly introduced in the present technology. For example, the registration module 215 associates B1 to Bn₂ of the 375 code, to A1 to An₂ of the 350 code representing the approximate performance, specification, standard, and the like of the building material, from among A1 to An₁ of the 350 code corresponding to the building material constituting the above-mentioned structure. Here, n₂ represents a numerical value (number) of kinds of building materials constituting the predetermined structure.

To give a concrete example for each building material constituting an interior wall, representations are set for clearly indicating the kinds such as: “LGS 65.0” for indicating a lightweight steel frame having a thickness of 65 mm; “GBR 9.5” for indicating a gypsum board made of semi-incombustible material having a thickness of 9.5 mm; and “GBR 12.5” for indicating a gypsum board made of incombustible material having a thickness of 12.5 mm. Then, the registration module 215 is capable of assigning the above-mentioned representations to the 350 code, as the 375 code. In addition, it is possible to express the attribute information relating to the building materials of the structure as a combination of the 375 codes of the respective building materials constituting the structure, for example, as “GBR 12.5_GBR 9.5_LGS 65.0_GBR 12.5_GBR 9.5” and the like.

The code 375 is uniquely assigned to a building material having a predetermined performance or specification. The 375 cord may be defined to have information relating to dimensions of a specification or the like of a LGS wall, but not to have information relating to dimensions of specific size (or actual size) or the like of a LGS wall. In addition, the 375 code may be represented by a symbol or the like that does not represent dimensions of specifications or the like of a LGS wall. For example, the 375 code may include information representing the existence or absence of a designation of a particular manufacturer or a designation of a particular building material (for example, “1” for existence, and “0” for absence).

However, there may be a case where the attribute information which is necessary for designating a building material is not included according to the BIM data to be used. In addition, there may be a case where the attribute information assigned to the BIM data cannot be appropriately assigned with the 375 code which is stored in the building code information 600. In such cases, the registration module 215 may associate the 375 code which is inferred to be appropriate, or may associate the temporary 375 code (for example, it may be “LOD 375 code”) which represents a general building material. In such a case, the registration module 215 may further associate information indicating that the appropriate 375 code may not be associated. For example, a flag displaying the uncertainty may be set in the inferred 375 code or the temporary 375 code.

The (d) 400 G code is made to be used as the representative of the (e) 400 code. The (e) code 400 is provided so as to correspond to a product which is capable of being used as a component constituting each building material. It is possible to assign a plurality of 400 codes to one 375 code. Because, as for a component of each building material, in general, equivalent or similar products satisfying a necessary standard are commercially available by the same or different building material manufacturers. However, in the present technique, the 400 G code is made to be used as the representative of the 400 code with respect to a plurality of products which are capable of being used for such a component. That is, the registration module 215 associates the 400 G code with the 375 code, and associates a plurality of 400 codes with the 400 G code.

For example, the code (e) 400 refers to a code corresponding to various building members (products) which are commercially available from building material manufacturers, as the components, and this code is associated with information relating to the building member (product). Information on such a building member is stored in the component information 700 of the auxiliary storage device 202. The (e) 400 code may be, for example, a product code itself that is representing a building member manufacturer and its building member. Therefore, it is possible to consider that the (d) 400 G code is the representative of the (e) 400 codes defined for one or a plurality of kinds of products satisfying a predetermined standard, for each approximate dimension, specification, and standard thereof (that is, the (d) 400 G code is used to collectively call the (e) 400 code). For example, the 400 G code may be a cord corresponding to a general name of a component.

Subsequently, the relation between the 375 code and the 400 G code will be described.

For example, when the building material represented by B1 of the 375 code is composed of n₃ pieces (or n₃ kinds) of components, the registration module 215 associates the B1 (which corresponds to 375 code) with C1, 1 to C1, n₃ (which correspond to n₃ pieces of 400 G codes). Specifically, for example, in a case where a LGS wall represented by LGS 65 is comprised of four pieces (or kinds) of components of a stud, a runner, an anti-sway, and a spacer, the registration module 215 associates the LGS 65 which is the 375 code, with the 400G code representing these four components (for example, C1, 1 to C1, 4).

In such a case, generally, a plurality of kinds of products are prepared for the products satisfying a predetermined standard, for the reasons of different sizes, different grades (for example, qualities), or different workabilities, as described above. Accordingly, the registration module 215 associates the appropriate 400G code, considering the 375 code and the attribute information such as the dimensions of the structure.

Also, the registration module 215 associates the C1, 1 to C1, 4 which are 400 G codes representing the respective components, with the 400 codes which are corresponding to the products capable of being used as the respective components. For example, the registration module 215 associates the C1, 1 which is the 400 G code for representing an anti-sway, with the C1, 1, 1 to C1, 1, n₅ which are the 400 codes. Each of n₅ and n₆ depicted in FIG. 5 represents the numbers of products which can be used based on a given component (for example, 400 G code: C1, 1, C1, 2). In this way, the registration module 215 directly or indirectly associates the codes (b) to (e) with the BIM data of the structure.

As is apparent from the above descriptions, the codes (b) to (e) represent the degree of detail of information relating to the building material, and the detail of information becomes finer as the code goes from the (b) 350 code toward the (e) 400 code. The 350 code is information at a stage of indicating a standard of a building material or a component constituting the building material. On the other hand, the code (e) 400 is information at a stage where the building material or the component constituting the building material is specified such that the order can be placed. By using the codes from (b) to (e), it is possible to express the information relating to the building materials constituting the structure at four levels of detail.

These codes can be associated with each other in a hierarchical manner as illustrated in FIG. 5, for example, each the (b) 350 code can be associated with the corresponding (c) 375 code, each the (c) 375 code can be associated with the corresponding (d) 400 G codes, and each the (d) 400 G code can be associated with the corresponding (e) 400 codes.

The component information 700 refers to product information on a component (or product) which can be used as a building material. For example, the component information 700 is capable of including information which is the same as or equivalent to information on a component listed in a product catalog of the building material manufacturer, and including information relating to the building material manufacturer, and the like. The component information 700 includes information relating to the product code and the manufacturer, or information relating to the order destination information and the product management code at the side of the selling company, or information necessary for placing an order for the product in a case where the information is coded. In addition, the component information 700 is capable of including information such as a corresponding specification, an image, a dimension, a material (or kind), a characteristic, and a reference price, for each component.

### Construction Management Method

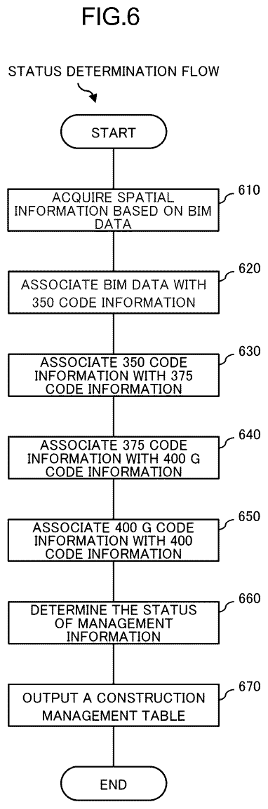

Subsequently, the construction management method using the construction management system 100 will be described. FIG. 6 depicts one example of a construction management flow. Typically, the construction management method can be performed according to the steps of from 610 to 670 of the construction management flow. The respective steps of from 610 to 650 of this construction-management-flow are steps in which the information (or BIM data) relating to a structure and the code information are associated with each other. It is possible to execute the steps 620 to 650 at an arbitrary timing, prior to the creation (or display) of a construction management table.

For example, when new BIM data (including BIM part data) is loaded into the construction-management-system 100, the steps 610 to 650 may be executed, and, on the other hand, when new BIM data is not loaded, the execution of these steps may be omitted.

The steps 660 to 670 refer to steps for outputting a construction management table. The steps 660-670 may be executed independently when the construction management table is outputted.

Hereinafter, for example, the “step 610” is represented in a simplified manner as “S610”.

### Association of Code Information

At the S610, the registration module 215 acquires spatial information based on BIM data. More specifically, the registration module 215 acquires, for example, for each structure, spatial information such as a floor (or story) and a room in which each structure is disposed, and information relating to a part such as a ceiling, a wall, and a floor. For example, the information relating to the acquired space is stored in association with the identification information of BIM data, in the management information 500.

At the S620, the registration module 215 associates the corresponding 350 code information with the BIM data. As for the 350 code to be associated, for example, the registration module 215 may inquire the BIM data in the database in which the 350 codes are stored in order to acquire the 350 code information corresponding to the BIM data.

In a case where the BIM data does not have attribute information to the extent that the 350 code information can be associated thereto, the registration module 215 determines that the code information cannot be associated with the BIM data, and then the registration module 215 ends the process for the BIM data. Then, the registration module 215 returns to the S610 and acquires spatial information based on the subsequent BIM data.

At the S630, the registration module 215 associates the corresponding 375 code information with the 350 code information. As for the 375 code to be associated, for example, the registration module 215 may inquire the 350 code in the database in which the 375 codes are stored in order to acquire the 375 code corresponding to the 350 code.

At the S640, the registration module 215 associates the 375 code information and the corresponding 400 G codes with each other. As for the 400 G codes to be associated, for example, the registration module 215 may inquire the 375 code and the necessary attribute information in the database in which the 400 G codes are stored in order to acquire the 400 G codes corresponding to the 375 code.

At the S650, the registration module 215 associates the 400 G code information and the corresponding 400 codes with each other. As for the 400 code to be associated, for example, the registration module 215 may inquire the 400 G code in the database in which the 400 codes are stored in order to acquire the 400 code corresponding to the 400 G code.

The registration module 215 is configured to be able to associate the codes (b) to (e) based on arbitrary BIM data. Association of the respective codes based on the BIM data may be carried out according to a predetermined classifying rule that has been determined based on a standard such as JIS standard provided for each building material in a structure, or may be carried by using a learning tool, or may be carried by using both of the two. When defining the classifying rule, it is possible to prepare a glossary in which a plurality of different terms representing the same content widely used in planning/designing are linked with each other, in order to unify fluctuations or variations of terms (which are used by the respective persons who create BIM data) into a single term.

The learning tool is configured to, for example, output a predetermined 350 code corresponding to a predetermined building material which is associated with BIM data on the basis of the attribute information, when the BIM data including the attribute information which is indicating the specification and standard of the building material constituting the predetermined structure is made to be the input value. As for the respective building members, since the standard such as JIS standard has been established, and accordingly, certain commonalities can be recognized although there are fluctuations in the creating forms of the BIM data. Therefore, such a learning tool can be realized such that as: a learning tool to which the unsupervised learning is performed; a learning tool to which the supervised learning is performed; or a learning tool to which the reinforcement learning is performed, etc.

For example, the registration module 215 is capable of storing the code information relating to the structure which is associated with the above-mentioned steps, as the management information 500, in association with the identification information of the structure, in the auxiliary storage device 202.

### Creation of Construction Management Table

At the S660, the status management module 214 determines the status of the management information. Specifically, the status management module 214 determines, based on the management information, whether the degree of detail of the information relating to the building material satisfies a predetermined condition.

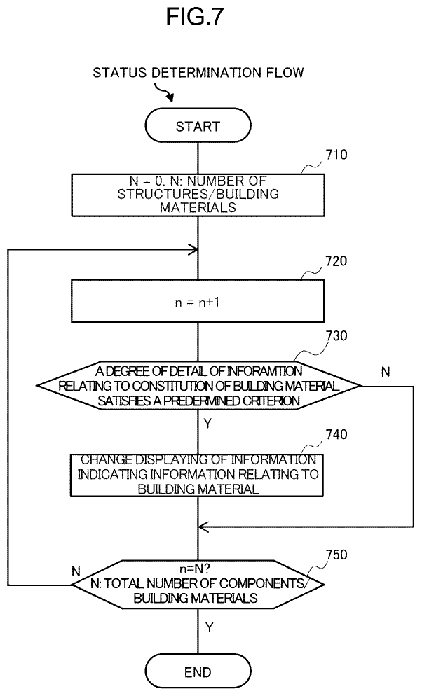

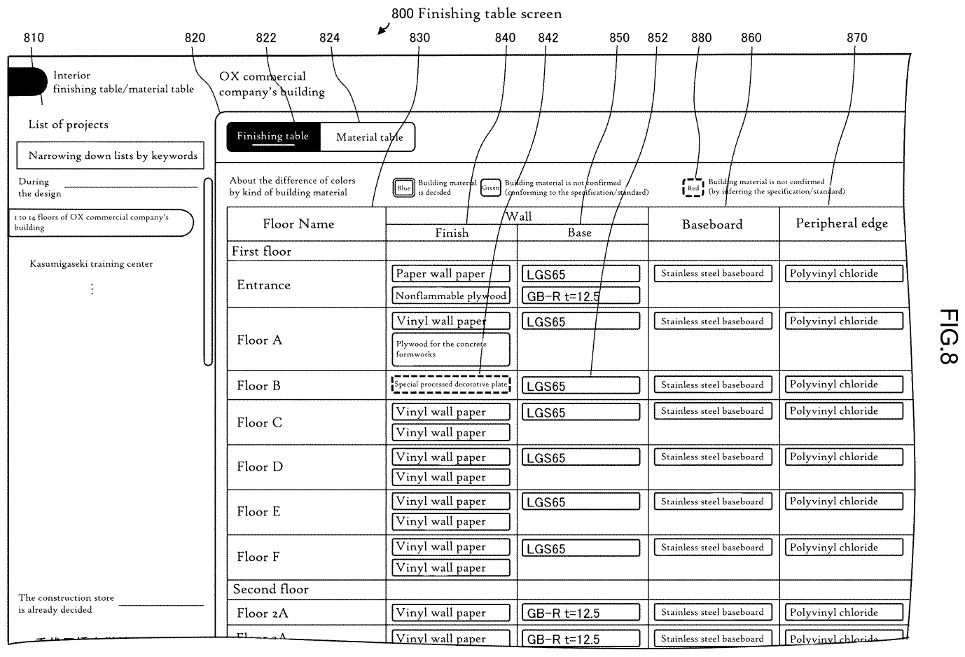

The status management module 214 is capable of executing processing associated with this determination, for example, according to the status determination flow illustrated in FIG. 7.

That is, at first, the status managing module 214 increments a determination counter n=0 (S710) by one (S720), and makes a decision and carries out a process on the first building material. The status management module 214 determines whether the above-mentioned degree of detail satisfies a predetermined criterion (S730). Specifically, for example, when a finishing table is created as a construction management table, the status management module 214 determines whether “it is at the stage where the degree of detail of the code information relating to the building material constituting the structure can specify the component of the building material by its general name or the like,” in other words, the status management module 214 determines whether the 400 G code is associated with the component of the building material.

Then, when the degree of detail of the information relating to the building material satisfies a predetermined criterion, in other words, when the 400 G cord is associated with the building material (Y in S730), for example, it sets a flag for changing the representation of “information indicating information relating to the building material” (S740). When the degree of detail of the information relating to the building material does not satisfy the predetermined criterion, that is, when the 400 G code is not associated with the building material (N in S730), the S740 is skipped.

The status management module 214 confirms whether the above-mentioned determination and the processes have been performed on all the building materials (S750), and when it is confirmed that the determination and the processes have been performed on all the building materials, and accordingly the determination counter reaches the total number of the building materials (Y in S750), then the status management module 214 terminates the flow. On the other hand, when the determination counter does not reach the total number of the building materials and the determination and the processes have not been performed on all of the building materials (N in S750), the status management module 214 returns to S720, and carries out the determination and the processes of S730 to S740 for the following building materials. This is repeated until the determination counter reaches the total number of the building materials (Y in S750).

For example, the flag information assigned by the status management module 214 is stored in the auxiliary storage device 202, as the management information 500.

At the S670, the output module 212 outputs (for example, displays) a construction management table to a display device of the user terminal 102. The output module 212 displays information indicating “information relating to the building material” for each structure, based on the management information, in the construction management table. For example, when displaying a finishing table as the construction management table, the “information relating to the building material” refers to the “kind of the building material”.

At this time, when the degree of detail of the information relating to the building material satisfies the predetermined condition, the output module 212 displays, about the “information indicating information relating to the building material”, in a different way from the case where the predetermined condition is not satisfied, in the construction management table. In other words, the output module 212 displays the building material to which the flag is set, in a different way from the case of the information relating to the building material to which the flag is not set.

### Finishing Table

FIG. 8 depicts an example of a finishing table screen 800 to be displayed on the user terminal 102. In FIG. 8, a part of the finishing table screen 800 and that of the finishing table 820 are illustrated.

The finishing table 820 is one example of the construction management table. The finishing table 820 is one kind of building drawings, and is made to be a list of finishings of at least one of the inside of the building and the outside of the building. At the left end of the finishing table screen 800, a project field 810 for displaying a list of project names is provided, and the output module 212 displays the finishing table 820 (of which the background color is changed.), on the right side area with respect to the project field 810, for the project of “1 to 14 floors of O? commercial company's building”.

The output module 212 displays a combination of a finishing table button 822 and a material table button 824 on the top of the finishing table 820. These buttons are configured such that when one of the two is selected, the other is made to be not selected. FIG. 8 illustrate a condition where the finishing table button 822 is selected, and the output module 212 displays the finishing table button 822 in a colored state in which the characters of “finishing table” are displayed in white and an underline is attached thereto. The output module 212 displays the material table button 824 with a white color and displays the characters of “material table” in a colored state (for example, with a black color).

The floor name field 830 is displayed in the field at the left end of the finishing table 820, and the output module 212 displays the names of rooms in a predetermined order for each floor therein. In the item field provided at the upper end of the other fields 840 to 870, the output module 212 sequentially displays the parts of each room such as a wall/finish, a wall/base, a baseboard, a peripheral edge, . . . and the like. In addition, in a cell which is specified by the floor name (which may be a room name) and the part, the output module 212 displays information relating to the “kind of building material” used for the part of the room which is indicated in the floor name field 830. As for the part using two or more building materials, the output module 212 displays the “kinds of the building materials” for the respective building materials.

In the finishing table 820, for example, the output module 212 displays information of “special processed decorative plate” in a cell 842 indicating the kind of the building material which is used for finishing the interior wall of the floor B. Similarly, in the finishing table 820, for example, the output module 212 displays information of “LGS 65” in a cell 852 indicating the kind of the building material which is used for the underground of the interior wall of the floor B. Also, for the information indicating the kind of the building material, the output module 212 may display the 375 codes (for example, GBR 12.5, GBR 9.5, LGS 65.0, and the like) as they are, but not limited to these examples.

From among the information relating to the kind of the building material displayed in the finishing table 820, the building material to be used for finishing the interior wall of the floor B is not made to be associated with the 400 G cord, and accordingly, a flag is not set on the information relating to the building material to be used for the finishing. As for the other building materials, the 400 G cords are associated thereto, and accordingly, a flag is set on each of the information relating to the other building materials.

In such cases, for example, the information of the “special processed decorative plate” relating to the kind of the building material displayed in the cell 842 is information at the level of LOD 375, and is not associated with the 400 G code, and accordingly, the output module 212 displays the representation of “special processed decorative plate” with red-colored characters, and also displays the frame surrounding the area indicating the above-mentioned information with red-colored broken lines. Also, the information relating to the kinds of the building materials displayed in the other cells are information at the levels of LOD 400 G or more, and accordingly, the output module 212 changes the representation of the information such that the information is displayed with green-colored characters, and the frame surrounding the area indicating the above-mentioned information is displayed with green-colored solid lines.

In addition, the output module 212 outputs explanatory notes 880 describing the changed representation and the content to the finishing table 820. This allows the user to recognize the content of the changed representation.

With this constitution, it is possible to create a material table at an arbitrary timing including, for example, a stage in which a building material to be used is not specifically determined. The representation of the information indicating the “kind of the building material” to be displayed in the material table is made to be changed in accordance with the degree of detail of the content. For example, the representation is changed between a state in which the information relating to the building material has been detailed to a level such that its general name of the component to be used for constituting the building material can be specified, and a state in which the information relating to the building material has not been detailed to a level such that its general name of the component to be used for constituting the building material cannot be specified. Accordingly, the user is allowed to recognize, at a glance, the degree of detail of the information relating to the building material to be used when the user sees the finishing table which is always created during the course of the construction work. In addition, this information can also be shared between the users.

Also, there may be a case where a new product or a special product is designated as a building material or the component in the BIM data, but the information relating to the product has not been registered (or stored) in the building code information 600 or the component information 700. In such a case, the 400G code is not associated with the BIM data corresponding to the building material, and accordingly, the output module 212 performs error display in red-colored characters to indicate that some information is included in the finishing table, but its corresponding code does not exist. Then, after the information relating to the building material specified in the building code information 600 or the component information 700 is registered, the registration module 215 associates appropriate 400 G code and 400 codes with the BIM data, and subsequently, the output module 212 may display the information relating to the kind of the predetermined building material with green-colored characters on the finishing table.

In addition, in a case where the BIM data contains incorrect data therein, it becomes impossible to appropriately associate the 400 G code with the BIM data corresponding to the building material. In such a case, the output module 212 displays the information indicating the kind of the building material in red-colored characters or the like in the finishing table. Therefore, the user is allowed to recognize that the content of the BIM may be incorrect by seeing the representation indicating that the degree of detail of the information relating to the building material is insufficient.

Furthermore, it is conceivable that the BIM model and the BIM data may be changed or modified after being created in either of the case where the design and the construction are performed separately and the case where the design and the construction are performed all together. With this constitution, after the finishing table is created based on the original BIM data, by capturing the changed or modified BIM data, it becomes possible to create a finishing table based on the changed or modified BIM data. In such a case, when the changed or modified BIM data does not contain information enough to specify the building material, the output module 212 displays the information indicating the kind of the building material with red-colored characters in the finishing table. Accordingly, the user who uses the construction-management-system 100 is allowed to easily confirm the lack of information in the changed BIM data, and becomes possible to take required measures (for example, obtaining the insufficient information).

In the above descriptions, the status management module 214 determines whether the degree of detail of the information relating to the constitution of the building material satisfies a predetermined criterion during the course of the status determination flow, and then sets a flag based on the determination. Also, when the predetermined condition is not satisfied, the output module 212 displays, with respect to the information indicating the information relating to the building material, the representation which is different from the case where the predetermined condition is not satisfied, according to the flag information. However, the status management module 214 does not necessarily have to set a flag, and may output the information indicating whether the degree of detail of the information relating to the constitution of the building material satisfies the predetermined criterion. In addition, for example, when the predetermined condition is satisfied, the output module 212 may display, with respect to the information indicating the information relating to the building material, the representation which is different from the case where the predetermined condition is not satisfied, according to the output result of the status management module 214.

### Assignment of Recommended Component

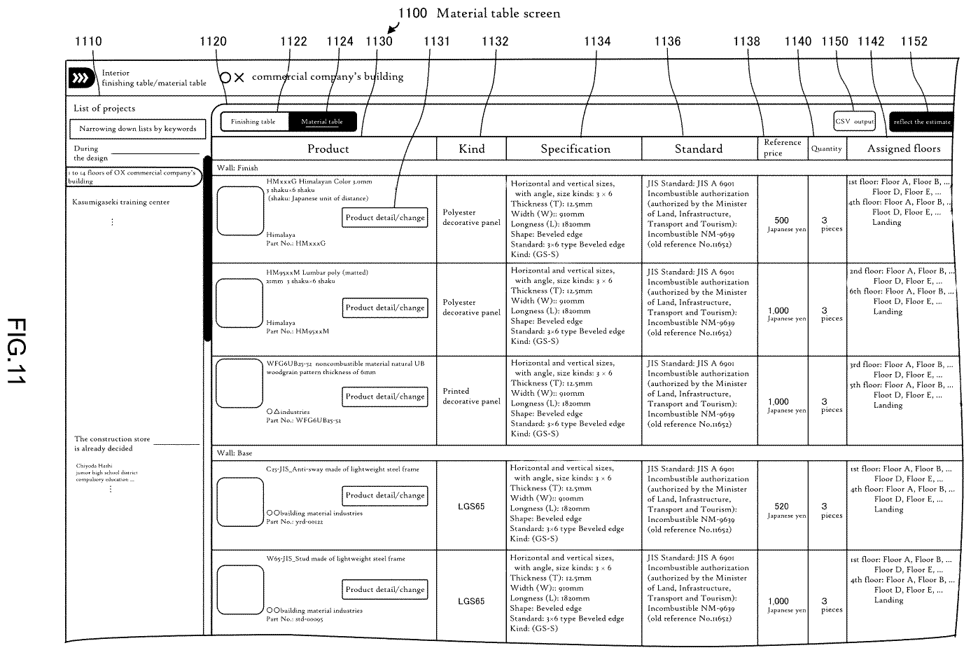

Subsequently, recommended components will be explained. For example, as for a case of the “anti-sway” which is one of components constituting the building material, the constituent part information 700 stores information on three pieces of products therein (see FIG. 10 described later). The three pieces of products are associated with the (d) 400 G code(s) corresponding to the building material and with the (e) 400 code(s) which is unique to each product. In this way, when there are a plurality of components having a common (d) 400 G cord, any one of a plurality of components having the common (d) 400 G cord may be assigned, as a recommended component.

It is possible to assign an arbitrary component to the recommended component. For example, a component determined based on a predetermined criterion may be assigned thereto. Also, for example, the assignment of recommended component may be performed manually by an administrator who manages the management server, or may be performed automatically by the registration module 215 when executing a predetermined program. For example, it is conceivable that a recommended component is determined based on the used history information on the components and the inventory information thereon. For example, the registration module 215 may be configured to assign a component to a recommended component when the inventory number of the components is larger than the number of the components required in the interior work, and when the using rate of the component in the past work is higher than the predetermined criterion (more preferably the percentage is the highest). The registration module 215 may store (register) that the component is assigned as the recommended component, for example, by setting a recommended flag thereon.

### Approval of Components

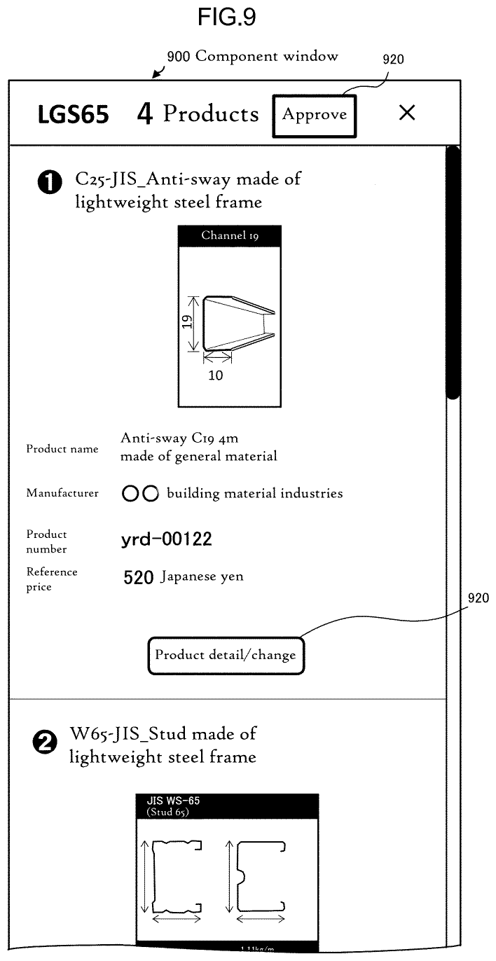

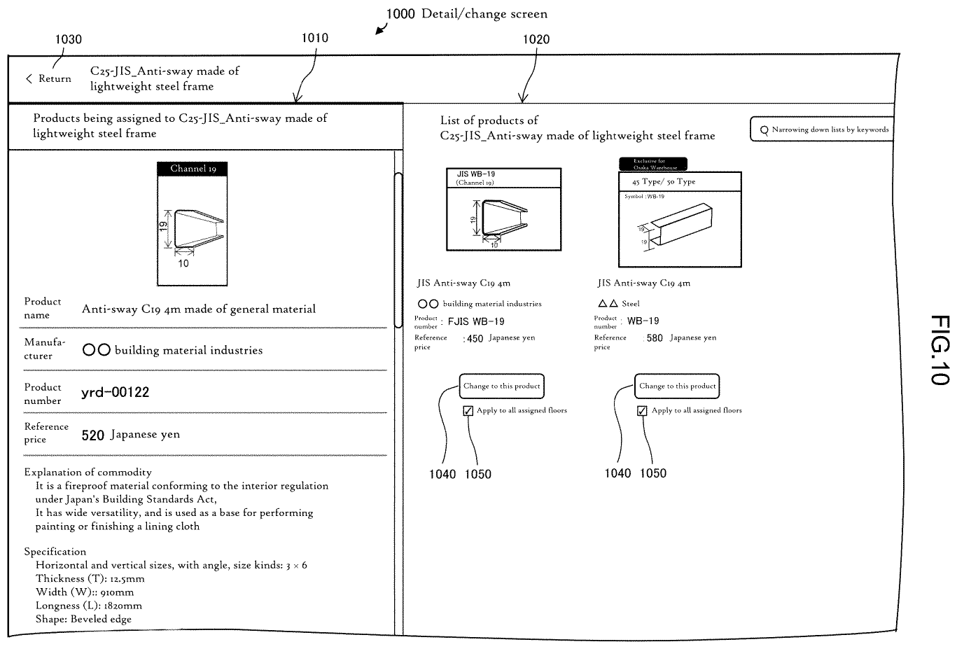

For example, the output module 212 displays the information indicating the “kind of building material” arranged in the cell of the finishing table 820 to be selectable on the screen of the user terminal 102. The user terminal management module 211 of the management server 101 is configured to be able to receive a selection of the information indicating the “kind of building material”, by cooperating with the user construction management module 312 of the user terminal 102. And when receiving a selection of the information indicating the “kind of building material”, the output module 212 outputs a component window 900 to the display device of the user terminal 102 to be displayed on the finishing table screen 800 (see FIG. 9), by cooperating with the user construction management module 312.

FIG. 9 depicts an example of the component window 900. In FIG. 9, a part of the component window 900 is illustrated.

In the component window 900, the output module 212 displays the information relating to the component constituting the building material to which the information of the “kind of building material” is selected. For example, when “LSG 65” indicating the kind of the building material which is displayed in the cell 852 of FIG. 8 is selected, the output module 212 displays the information relating to four pieces of components which are used for constituting the building material LSG 65 in the component window 900. In a case where there are a plurality of components having the common (d) 400 G cord, the output module 212 displays a component which is recorded as the recommended component in the window 900, as mentioned above. It is possible to obtain the information relating to the component from the component information 700, for example, based on at least one of the (d) 400 G code(s) and the (e) 400 code(s) which are associated with the building material.

The output module 212 displays information such as a name, an image, a product name, a manufacturer, a product number, and a reference price for each component (or recommended component) constituting a building material in the component window 900. Also, the output module 212 displays a “product detail/change” button 920 along with the information on each component in the component window 900. Then, when the change reception module 213 receives a selection of the “product detail/change” button 920 from the user, it displays a detail/change screen 1000 (see FIG. 10), which will be described later.

In addition, the output module 212 displays an approval button 910 at the upper side of the component window 900. By selecting the approval button 910, the user is allowed to approve each component displayed in the component window 900 as a product to be used in the construction work. Then, when receiving the selection of the approval button 910 from the user, the registration module 215 stores (or records) that each component displayed in the component window 900 is approved as the component to be used in the construction work (for example, it sets an approval flag thereto).

The registration module 215 stores the information relating to the recommended component or the approval (for example, the recommended flag information or the approval flag information) as the management information 500 in association with the 400 code for the BIM data, in the auxiliary storage device 202, but not limited to this case.

It is conceivable that the degree of detail of the information relating to the building material is increased, for the building material to which all components are approved. The present construction management system 100 is capable of indicating a stage in which the degree of detail of the information relating to the building material is increased, by changing the representation in the finishing table. For example, it may be configured to execute the S660 to S670 of the construction management flow when a component constituting a building material is approved.

That is, the status management module 214 determines whether the degree of detail of the information relating to the building material satisfies the predetermined condition based on the management information at the step of S660. In such a case, for example, the status management module 214 determines whether “the information indicating that the component constituting the building material has been approved is recorded”. In other words, the status management module 214 determines whether the component of the building material is approved (or whether an approval flag is set).

Then, when the degree of detail of the information relating to the building material satisfies a predetermined criterion, in other words, when an approval flag is set on the building material, the output module 212 changes the representation of the information indicating the kind of the building material, and then outputs the finishing table (S670). For example, for the building material to which all the components have been approved, the output module 212 displays further different representation with respect to the information indicating the kind of the building material displayed in the finishing table 820. Specifically, although not illustrated in the figures, the output module 212 is capable of changing the representation. For example, the output module 212 displays “LGS 65” which is the information relating to the kind of the building material to be displayed in the cell 852 with blue-colored characters, and displays the frame surrounding the area indicating the above-mentioned information with blue-colored double lines.

According to the present embodiment, the output module 212 is capable of changing the representation (in this example, the color) of the information indicating the kind of the building material, for example, as follows. However, the following representation modes are merely examples, and not limited to these cases.
At a stage in which at least one of four components constituting a building material is not assigned with a product which is capable of being used as the component, the representation is displayed with “red color”
At a stage in which at least one of four components constituting a building material is not assigned with a product, the representation is displayed with “red color”, but at a stage in which all of four components constituting the building material are assigned with products, the representation is changed from “red color” to “green color”
At a stage in which at least one of four components constituting the building material is not approved, the representation is displayed with “green color”, but at a stage in which all of four components constituting the building material are approved, the representation is changed from “green color” to “blue color”
At a stage in which a change of product is received for at least one of four components constituting the building material, the representation is changed from “blue color” to “green color”

In the case of the present embodiment, the approval button 920 is provided for concurrently approving all of four components which are constituting the building material. However, it is also possible to provide the approval button 920 for each of the components constituting the building material. In such a case, the status management module 214 may determine whether “the information indicating that the component constituting the building material has been approved is recorded with respect to a predetermined rate of the components”. In addition, the output module 212 may be configured to change the representation of the information indicating the kind of building material, in the finishing table, every time when the rate of approved components satisfies a predetermined criterion.

Also, in the present embodiment, the output module 212 performs the determination of whether the degree of detail of the information relating to the building material satisfies a predetermined criterion, by confirming whether the approval flag is set for the building material. However, the output module 212 may be configured to perform the determination of whether the degree of detail of the information relating to the building material satisfies a predetermined criterion, without interposing (or using) the approval flag, at every time. In a case where the degree of detail of the information relating to the building material satisfies the predetermined criterion, the output module 212 outputs the finishing table, by changing the representation of the information indicating the kind of the building material to be different from the case where the predetermined criterion is not satisfied.

### Change of Recommended Component

FIG. 10 depicts an example of the detail/change screen 1000. For example, the detail/change screen 1000 is displayed by the change reception module 213 when the “product detail/change” button 920 displayed in the component window 900 is selected. In addition, the detail/change screen 1000 is displayed by the change reception module 213, when the “product detail/change” button 1131 displayed in the material table 1120, which will be described later, is selected.

The change reception module 213 displays the information relating to the recommended component(s) on the left side 1010 of the detail/change screen 1000. In addition to the information displayed in the component window 900, the change reception module 213 also displays the product description with respect to the recommended component and the information relating to the specification, on the detail/change screen 1000.

On the right side 1020 of the detail/change screen 1000, the change reception module 213 displays the information about the other components having the (d) 400 G code which is common to the recommended component. For example, the information about the other components may be obtained from the component information 700 according to the (d) 400 G code which is associated with the building material. Accordingly, the detail/change screen 1000 displays the information about all the components included in the (d) 400 G cord to which the building material is associated.

For example, the change reception module 213 displays information such as a name, an image, a product name, a manufacturer, a product number, and a reference price for each of other components, on the right side 1020 of the detail/change screen 1000 in the same way as the case displayed in the component window 900. The output module 212 displays a “button for changing to this product” 1040, for each of the other components, together with information about the other component, on the right side 1020 of the detail/change screen 1000. When receiving a selection of the “button for changing to this product” 1040 displayed to any one of the other components, from the user, the change reception module 213 is capable of assigning the other component which is corresponding to this button 1040 as the recommended component.

Below each of the “button for changing to this product” 1040, the change reception module 213 displays a check box 1050 with a comment of “applying to all assigned floors. The check box 1050 is normally in a condition of being unchecked, and the selection of the check box 1050 causes it to be in a condition of being checked. The assigned floor refers to a floor (room) to which the same component is assigned, and for example, it can be confirmed in the material table 1120, which will be described later.

When receiving a selection of the “button for changing to this product” 1040, in a condition of being unchecked (checked out) of the check box 1050, the change reception module 213 assigns the other component which is corresponding to the button 1040 as a recommended component, only for the floor (room). On the other hand, when receiving a selection of the “button for changing to this product” 1040 in a condition of being checked of the check box 1050, the change reception module 213 concurrently receives a change of the recommended component, even with the component(s) of the other floor(s) to which the recommended component is assigned. In other words, it assigns the other component corresponding to the button 1040, also for the assigned floor, as the recommended component.

When receiving a selection of the button 1040, the change reception module 213 records that the other component corresponding to the button 1040 becomes a new recommended component. For example, it removes a recommended flag on a component which has been previously recorded as a recommended component, and sets a recommended flag on the other component which is corresponding to the button 1040.

In addition, the change reception module 213 may be configured, when receiving a change in the component which has already been approved, to remove a recommendation flag which has been assigned to the original recommended component and also remove an approval flag.

The output module 212 accordingly displays information relating to the newly assigned recommended component, on the left side 1010 of the detail/change screen 1000. In addition, the output module 212 displays information relating to the other component(s), on the right side 1020 of the detail/change screen 1000. Accordingly, it is possible to change the product which is assigned as the component.

For example, the change reception module 213 displays a “return” button 1030 on the upper left side of the detail/change screen 1000. When receiving a selection of the “return” button 1030 from the user, the output module 212 displays a display screen (which can be the finishing table screen 800 or the material table screen 1100) which has been displayed before the displaying of the detail/change screen 1000. In a case where the recommended flag is removed in accordance with the change in the component, an unapproved component is assigned to the building material which is configured by using the component. Therefore, the output module 212 appropriately changes the representation of the information relating to the kind of the building material. For example, the output module 212 changes the representation of the information relating to the kind of the building material which has been displayed with the blue-colored characters and the blue-colored frame, to the representation with the green-colored characters and the green-colored frame. When receiving a change of the recommended component for a plurality of the building materials, the output module 212 changes the representation of the information relating to the kind of the building material which has been displayed with the blue-colored characters and the blue-colored frame, to the representation with the green-colored characters and the green-colored frame, for all of a plurality of the components to which the change is received.

According to the present embodiment, there are two ways to select the change in the recommended component: that is, the change is performed only for the floor (or room); or the change is performed for all the other assigned floors (or rooms). However, the change of the recommended component may be performed after selecting the floor (or room) to be changed. In such a case, for example, the registration module 215 may be configured to receive a registration of a group constituting two or more floors (or rooms). Then, the change reception module 213 may be configured to receive a change of recommended components for each group. For example, it is possible to associate rooms which are designed to have high soundproofing performance as a group belonging to one (for example, a soundproofing room flag is set to each room), and to receive a change for each group to change the recommended components to products having higher soundproofing performance, for each group.

### Material Table

FIG. 11 depicts an example of the material table screen 1100. The material table 1120 is another example of the construction management table. The material table 1120 illustrated in FIG. 11 is given for the purpose of explaining the constitution of the material table, and the details of the material table and those of the finishing table illustrated in FIG. 8 may not necessarily be matched to each other.

When the user select the material table button 824 on the finishing table screen 800, the material table 1120 is made to be displayed. When receiving a selection of the material table button 824 from the user, the output module 212 displays the material table screen 1100 on the output device 305 of the user terminal 102.

The output module 212 displays a combination of a finishing table button 1122 and the material table button 1124 on the upper side of the material table 1120. These buttons are configured such that when one of the two is selected, the other is made to be not selected, similar to the case of the finishing table button 822 and the material table button 824. FIG. 11 illustrates a state in which the material table button 1124 is selected, and the output module 212 displays the material table button 1124 in a colored state in which the characters of “finishing table” are shown with a white color and an underline is attached thereto. The output module 212 displays the “finishing table” in a white color, and also displays the characters of “finishing table” in a colored state (for example, with a black color).

The output module 212 outputs the project field 1110 at the left end of the material table screen 1100, similar to the case of the finishing table screen 800. The output module 212 displays the material table 1120 to the right side relative to the project field 1110.

In the material table 1120, components constituting a building material are arranged for each part, and the attribute information of a variety of kinds of these components is displayed in a list format.

There is a product field 1130 at the left end of the material table 1120, and the output module 212 displays information relating to the products (recommended components or approved components) which are assigned as the components constituting the building materials of the structure along the vertical direction, for the respective parts of the target building. For example, the information relating to the component displayed in the product field 1130 may be the same as the information relating to the recommended component displayed in the component window 900. In addition, the output module 212 displays a “product detail/change” button 1131 in the product field 1130.

In the material table 1120, the output module 212 arranges the kind field 1132, the specification field 1134, the standard field 1136, the reference price field 1138, the quantity field 1140, and the assigned floor field 1142 in this order in a manner to be aligned with the product field 1130. In each of these fields, attribute information such as the kind, the specification, the standard, the reference price, the quantity, and the assigned floor with respect to the component displayed in the product field 1130 is displayed. The output module 212 displays the name of room(s) in which the corresponding component(s) is used, in the assigned floor field 1142. The components can be grouped across rooms to be used, on each room as a unit.

When the “product detail/change” button 11310 is selected by the user in the material table 1120, it becomes possible to display the detail/change screen 1000 and to change the recommended component as described above. Also, when receiving a selection of the “product detail/change” button 11310 from the user, the output module 212 displays the detail/change screen 1000. Accordingly, it is possible to receive a change in the recommended component, as described above. When the recommended component is changed, the output module 212 changes the component to be displayed in the material table 1120, to the information relating to the changed recommended component, and displays it.

Although not specifically shown, the output module 212 may change the representation of the information relating to the approved component so as to be different from the representation of the information relating to the unapproved component, even at the outputting of the material table. In such a case, the output module 212 may output the outer frame of a cell displaying information, by changing the line type of the frame line thereof, for example, the output module 212 may change the outer frame of a cell displaying information relating to the approved component to be different from the outer frame of a cell displaying information relating to the unapproved component, by thickening the frame line of the outer frame. Alternatively, or in addition thereto, the output module 212 may change the color of the frame line or the color of the area inside the cell. Alternatively, or in addition thereto, the output module 212 may display a “mark as being approved” in a cell which is displaying information relating to the approved component, or may display a “mark as not being approved” in a cell displaying information relating to the unapproved component. One of these marks may be displayed at only one stage, and this mark may be changed to the other mark when the stage is changed.

With this constitution, the output module 212 is capable of concurrently outputting information indicating the structure associated with the building material(s) which is specified based on the management information, for each information relating to the building material. With this constitution, the output module 212 is capable of outputting information relating to the kind, the reference unit price, the quantity, and the like of the component to be used in the target building, for example, in the form of the material table. Based on the above-mentioned information, for example, it becomes possible to easily perform the calculations of the cost estimates of the building materials and the like associated with the interior construction.

Also at this time, it is possible to perform the calculations of the cost estimates based on the assigned recommended components, even in a stage in which one or a plurality of components are not approved. This facilitates the cost management and also makes it possible to secure the budget for procuring components at an early stage of the construction. Therefore, it becomes possible to suppress an occurring a shortage of budget or a rework during the course of the interior construction at the post-process, as compared with the prior art in which. for example. when a budget excess occurs at the pre-process, a shortage can easily occur at the post-process.

With this constitution, the degree of detail of information relating to the building material is made to be an index for indicating the degree of detail of information in a range of from the information of the stage in which the standard or kind of the building material or the component constituting the building material is indicated, to the information of the stage in which an order can be placed for the building material or the component constituting the building material. Therefore, it is possible to visually add the degree of the management progress of the component to which an order can be placed, to the information which is displayed in the construction management table such as the finishing table.

For example, the degree of detail of information relating to the building material can be divided into a first stage in which the standard of the building material or the component constituting the building material can be indicated, a second stage in which the product information relating to the product of the building material or the component conforming to that standard can be indicated, and a third stage in which an order can be placed for the product. As a result, it is possible to change the representation of the information indicating the kind of the building material, for example, in the finishing table, at each stage. This allows the change in the representation of the information indicating the kind of building material to be linked to the three main stages of the management of the building material or the components. Therefore, it is possible to visually express the degree of the management progress of the component to which an order can be placed, in more detail, and thus it is useful.

The first step corresponds to the LOD 350 which is an index relating to the shape information and the attribute information of BIM model, and the third step corresponds to the LOD 400. According to the present technique, the stages corresponding to the LOD 350 and the LOD 400 and the stage provided therebetween are separated from each other, and accordingly, the representation of the information to be displayed in the construction-management table is made to be changed. As a result, when the information corresponding to the LOD 350 is expanded to the information corresponding to the LOD 400, it is possible to effectively display the information to be supplemented and the points to be confirmed, in the construction management table.

In the above configuration, the predetermined condition for changing the representation of the information is stored such that the information relating to the structure (for example, the kind of the building material) and the information relating to the building material with respect to the component constituting the building material (for example, information indicating that the component is specified with a certain degree of detail) are associated with each other. In yet another aspect, the predetermined condition means that the building material or the component constituting the building material is approved. In addition, the predetermined condition may mean that all components constituting the building material are approved.

In a case where the information relating to the structure is stored in association with the information relating to the building material with respect to the component constituting the building material, the output module 212 displays, in the construction management table, the information indicating information relating to the building material, and the information which is different from the case where the predetermined condition is not satisfied. With this constitution, it is possible to display information which cannot be displayed as character information in the construction management table, such as a particular degree of a component, as a change in the representation. In addition, it is possible to display, for example, information relating to the presence or absence of the approval for the component as the change in the representation, on the finishing table, in addition to the information relating to the building material. Accordingly, this finishing table can be used as a tool for the progress confirmation and the progress management, and it is possible to add a new function to the finishing table. Such an effect can be further exhibited by combining with the constitution which enables to create a finishing table from an early stage, as in the present technology.

With this constitution, the output module 212 may be configured to perform at least one of the following functions when a predetermined condition is satisfied.
Changing a color of at least one of a character and a symbol indicating the building material
Changing a color of an area containing information relating to a building material constituting a structure
Changing a color of a frame of an area containing information relating to a building material constituting a structure
Changing a line type of a frame line of an area containing information relating to a building material constituting a structure
Displaying a character string, a mark, a symbol, or the like indicating that a predetermined condition is satisfied

Accordingly, the representation can be changed such that it enables a person to easily visually recognize the representation.

With this constitution, the construction management system 100 includes a change reception module 213 for receiving a change in a component constituting a building material, which is associated with information relating to a structure. In addition, building materials or components of the same kind are grouped together. Then, the change reception module 213 may be configured, when a change of one building material or component is received, to change the other building materials or components included in the same group as the above-mentioned one building material or component. With this constitution, it is possible to efficiently change and approve the grouped components without omission.

With this constitution, the building materials or the components may be grouped together when belonging to the same kind across one or a plurality of spaces dividing the building. Then, the change reception module 213 may be configured, when a change in the kind of one building material or component is received, to change the representation of the information relating to the building material with respect to the other building materials or components included in the same group as the above-mentioned one building material or component, across the spaces. With this constitution, it is possible to efficiently change and approve the components which are grouped together across the spaces, without omission. Such a configuration is particularly useful because the complexity at the time of changing the components can be greatly reduced, especially, when performing the construction work of a building which is divided into a large number of spaces.

With this constitution, the change reception module 213 and the output module 212 are configured, when a change in the kind of one building material or component is received, to change the representation of the information relating to the building material across the spaces, for all of the other building materials or components included in the same group as the above-mentioned one building material or component. However, the change reception module 213 and the output module 212 may be configured, when a change in the kind of one building material or component is received, to change the representation of information relating to the building material across spaces, with respect to one or a plurality of the other building materials or components which are selected from the other building materials or components included in the same group as the above-mentioned one building material or component.

In such a case, the change reception module 213 may be configured such that it can arbitrarily select the other building materials or components to be changed from among the other building materials or components included in the same group. For example, with respect to the other building materials or components, it is possible to accept a selection of the other building materials or components to be changed, according to a selection of a check box, or a selection operation by a cursor from the user. Such a configuration is particularly useful in a case where a specification change occurs in a structure.

With this constitution, the building materials or components may be grouped by spaces for dividing the building. And the change reception module 213 may be configured, when a change of one building material or component is received, to change the other building materials or components included in the same group as the above-mentioned one building material or component. For example, there may be cases where a function or a design required for the finishing material is greatly changed for each room. In such a case, it may be configured to change a predetermined standard of the building material or component to a different predetermined standard, on each room as a unit.

With this constitution, the construction management system 100 may be configured to include a status management module 214 for managing information relating to the component constituting the building material associated with information relating to the structure. When the status management module 214 receives a change of one building material or component, the output module 212 may display the information indicating the information (for example, kind of building material) relating to the other building materials or components included in the same group as the above-mentioned one building material or component, with the information which is different from the case where a change of the one building material or component is not received. For example, if a change is received for a building material or component once approved, the building material or component may become an unapproved building material or component after the change. In such a case, for example, the output module 212 may be configured to restore the representation which has been previously changed in a finishing table to its original form.

The present technology is not limited to the above-described embodiments, and includes various modifications. For example, the above-described embodiments have been described in detail such that the present technology can be easily understood, but, the present technology is not necessarily limited to the cases having all the described configurations. It is also possible to replace a part of one configuration of one embodiment with that of another embodiment, and also possible to add a configuration of one embodiment to that of another embodiment. In addition, it is also possible to add, delete, or replace a part of a configuration of each embodiment with respect to another configuration.

Each module disclosed in the above-described embodiments may be configured by combining a plurality of sub-modules. In addition, some or all of operations or functions to be executed or realized by one module may be executed or realized by another module.

The present technology not only provides an invention relating to the construction management system 100, but also provides an invention relating to the construction management method, in another aspect. The construction management method includes a step of displaying information indicating information relating to a building material, for each structure, according to management information in which information relating to a structure constituting a building and information relating to a building material constituting the structure are associated with each other, in a construction management table. In addition, at the step of displaying information, in a case where a degree of detail of information relating to a constitution of the building material satisfies a predetermined condition, based on the management information, information which is different from a case where the criterion (or condition) is not satisfied, is displayed with information indicating a kind of the building material of the structure, in the construction management table.

The present technology also provides a program for causing a server to execute each step of the construction management method. This program may be composed of one program or may be composed of two or more subprograms. Further, it may be a program for causing the server to execute any one or two or more of the above-described steps.

The present technology also provides a program for causing a computer to execute each step of the construction management method. This program may be composed of one program or may be composed of two or more subprograms. Further, the program may be a program for causing the computer to execute any one or two or more of the above-described steps.

In addition, some or all of the above-described constitutions, functions, processing units, processing means, and the like may be realized by a hardware, for example, by designing them with an integrated circuit. The above-described constitutions, functions, and the like may be realized by a software, for example, by using a processor capable of interpreting and executing a program for realizing the respective functions. It is possible to store information such as programs, tables, and files capable of realizing the respective functions in a storage device such as a memory, a hard disk, or an SSD (Solid State Drive), or a storage medium such as an IC card, an SD card, or a DVD.

In addition, control lines and information lines considered to be necessary for explanation are illustrated, but not necessarily all the control lines and the information lines are illustrated in the product. In practice, almost all of the constitutions may be considered to be interconnected with each other.

In addition, from among one or a plurality of the management servers 101 and one or a plurality of the user terminals 102 constituting the present construction management system 100, any one or two or more of the configuration elements may be installed in different countries. Further, the management server 101 may be realized by one or a plurality of computers, and any one of them may be installed in different countries.

The above-described embodiments disclose at least the following configurations:
(1) A construction management system for managing a construction of a building, includes:
a storage device storing management information in which information relating to a structure constituting a building and information relating to a building material constituting the structure are associated with each other; and
an output unit (or output device) for displaying information indicating the information relating to the building material, for each the structure, according to the management information, in a construction management table of the building,
wherein, in a case where a degree of detail of the information relating to the building material satisfies a predetermined condition, the output unit displays a representation which is different from a case where the predetermined condition is not satisfied, with respect to the information indicating the information relating to the building material, in the construction management table.
(2) The construction management system according to (1), wherein the degree of detail of the information relating to the building material is made to be an index for indicating the degree of detail of information in a range of from information at a level where a standard of the building material or a component constituting the building material is indicated, to information at a level where an order can be placed for the building material or the component constituting the building material.
(3) The construction management system according to (1) or (2), wherein the degree of detail is divided into:
a first level where a standard of the building material or a component constituting the building material can be indicated;
a second level where product information relating to a product of the building material or the component satisfying the standard can be indicated; and
a third level where an order can be placed for the product.
(4) The construction management system according to (3), wherein the first level is LOD 350, and the third level is LOD 400.
(5) The construction management system according to any one of (1) to (4), wherein the predetermined condition means that the information relating to the structure is associated with the information relating to the building material with respect to a component constituting the building material; and
wherein, in a case where the information relating to the structure and the information relating to the building material with respect to the component constituting the building material are associated with each other and stored, the output unit displays the information indicating information relating to the building material, and information which is different from a case where the predetermined condition is not satisfied, in the construction management table.
(6) The construction management system according to any one of (1) to (5), wherein the predetermined condition means that the building material or a component constituting the building material is approved;
wherein, in a case where the building material or the component constituting the building material is approved, the output unit displays a representation which is different from a case where the predetermined condition is not satisfied, with respect to the information relating to the building material, in the construction management table.
(7) The construction management system according to any one of (1) to (6), wherein the predetermined condition means that all components constituting the building material are approved, and
wherein, in a case where all components constituting the building material are approved, the output unit displays a representation which is different from a case where the predetermined condition is not satisfied, with respect to the information indicating a kind of the building material, in the construction management table.
(8) The construction management system according to any one of (1) to (7), wherein, in a case where the predetermined condition is satisfied, the output unit performs any one of:
changing a color at least one of a character or a symbol indicating the building material;
changing a color of an area including information indicating the building material of the structure; and
changing a color of a frame of an area including information indicating the building material of the structure.
(9) The construction management system according to any one of (1) to (8), further comprising a change reception unit (or change reception module) for receiving a change of a component constituting the building material to which information relating to the structure is associated;
wherein the building materials or the components are grouped when belonging to same kind; and
wherein, in a case where the change reception unit receives a change of one of the building material and the component, the change reception unit changes other building materials or components included in the same group of the one of the building material and the component.
(10) The construction management system according to (9), wherein the building materials or the components are grouped when belonging to same kind across a space dividing the building; and
wherein, in a case where the change reception unit receives a chang of a kind of one of the building material and the component, the change reception unit changes a representation of information relating to the building material with respect to the other building materials or the components included in the same group of the one of the building material and the component, across the space.
(11) The construction management system according to (10), wherein, in a case where the change reception unit receives a change of a kind of one of the building material and the component, the change reception unit changes a representation of information relating to the building material with respect to one or a plurality of the other building materials or the components which are selected from among the other building materials or the components included in the same group of the one of the building material and the component, across the space.
(12) The construction management system according to any one of (9) to (11), further comprising a change reception unit for receiving a change of a component constituting the building material which is associated with information relating to the structure,
wherein the building material or the component are grouped by a space dividing the building; and
wherein, in a case where the change reception unit receives a change of one of the building material and the component, the change reception unit changes other building materials or components included in the same group of the one of the building material and the component.
(13) The construction management system according to any one of (1) to (12), further comprising a status management unit (or status management module) for managing information relating to a component constituting the building material which is associated with information relating to the structure;
wherein, in a case where the status management unit receives a change of one of the building material and the component, the output unit displays information which is different from a case where a change of one of the building material and the component is not received, with information indicating information relating to other building materials or components included in the same group of the one of the building material and the component.
(14) The construction management system according to any one of (1) to (13), wherein the output unit outputs, for each space of the building, information relating to the building material in association with the structure arranged in the space.
(15) The construction management system according to any one of (1) to (14), wherein the output unit collectively outputs information indicating the structure associated with the building material which is identified based on the management information, for each information relating to the building material.
(16) A construction management method for managing a construction of a building, including:
a step of displaying information indicating information relating to a building material, for each structure, according to management information in which information relating to a structure constituting the building and information relating to a building material constituting the structure are associated with each other, in a construction management table; and
wherein, at the step of displaying information, in a case where a degree of detail of information relating to a constitution of the building material satisfies a predetermined condition, based on the management information, information which is different from a case where the predetermined condition is not satisfied is displayed with information indicating a kind of the building material of the structure, in the construction management table.
(17) A program for causing a computer to execute each step of the construction management method according to (16).

### EXPLANATION OF REFERENCE NUMERALS

100 . . . Construction management system, 101 . . . Management server, 102 . . . User terminal, 211 . . . User terminal management module, 212 . . . Output module (or output unit), 213 . . . Change reception module (or change reception unit), 214 . . . Status management module (or status management unit), 215 . . . Registration module, 311 . . . User execution module, 312 . . . User construction management module.

1. A construction management system for managing a construction of a building, comprising:
a processor; and
a storage device storing management information in which information relating to a structure constituting a building and information relating to a building material constituting the structure are associated with each other, the storage device storing instructions executable by the processor to cause the processor to:
output a construction management table of the building; and
display information indicating the information relating to the building material, for each the structure, according to the management information, in the construction management table;
wherein, in a case where a degree of detail of the information relating to the building material satisfies a predetermined condition, the processor causes the display of the information indicating the information relating to the building material in the construction management table, in a manner that differs from a case where the predetermined condition is not satisfied.

2. The construction management system according to claim 1, wherein the degree of detail of the information relating to the building material is made to be an index for indicating a degree of detail of information, in a range of from information at a level where a standard of the building material or a component constituting the building material is indicated, to information at a level where an order can be placed for the building material or the component constituting the building material.

3. The construction management system according to claim 1, wherein the degree of detail is divided into:
a first level where a standard of the building material or a component constituting the building material can be indicated;
a second level where product information relating to a product of the building material or the component satisfying the standard can be indicated; and
a third level where an order can be placed for the product.

4. The construction management system according to claim 3, wherein the first level is LOD 350, and the third level is LOD 400.

5. The construction management system according to claim 1, wherein the predetermined condition means that the information relating to the structure is associated with the information relating to the building material with respect to a component constituting the building material; and
wherein, in a case where the information relating to the structure and the information relating to the building material with respect to the component constituting the building material are associated with each other and are stored, the processor causes the information indicating information relating to the building material, and information in a manner different from a case where the predetermined condition is not satisfied, in the construction management table.

6. The construction management system according to claim 1, wherein the predetermined condition means that the building material or a component constituting the building material is approved;
wherein, in a case where the building material or the component constituting the building material is approved, the processor causes a representation in a manner different from a case where the predetermined condition is not satisfied, with respect to the information relating to the building material, in the construction management table.

7. The construction management system according to claim 1, wherein the predetermined condition means that all components constituting the building material are approved, and
wherein, in a case where all components constituting the building material are approved, the processor causes a representation in a manner different from a case where the predetermined condition is not satisfied, with respect to the information indicating a kind of the building material, in the construction management table.

8. The construction management system according to claim 1, wherein, in a case where the predetermined condition is satisfied, the processor performs any one of:
changing a color at least one of a character or a symbol indicating the building material;
changing a color of an area including information indicating the building material of the structure; and
changing a color of a frame of an area including information indicating the building material of the structure.

9. The construction management system according to claim 1,
wherein the processor is configured to receive a change of a component constituting the building material to which information relating to the structure is associated;
wherein the building materials or the components are grouped when belonging to same kind; and
wherein, in a case where the processor receives a change of one of the building material and the component, the processor changes other building materials or components included in the same group of the one of the building material and the component.

10. The construction management system according to claim 9, wherein the building materials or the components are grouped together when belonging to same kind across a space dividing the building; and
wherein, in a case where the processor receives a change of a kind of one of the building material and the component, the processor changes a representation of information relating to the building material with respect to the other building materials or the components included in the same group of the one of the building material and the component, across the space.

11. The construction management system according to claim 10, wherein, in a case where the processor receives a change of a kind of one of the building material and the component, the processor changes a representation of information relating to the building material with respect to one or a plurality of the other building materials or the components which are selected from among the other building materials or the components included in the same group of the one of the building material and the component, across the space.

12. The construction management system according to claim 9, wherein the processor is configured to receive a change of a component constituting the building material which is associated with information relating to the structure,
wherein the building material or the component are grouped by a space dividing the building; and
wherein, in a case where the processor receives a change of one of the building material and the component, the processor changes other building materials or components included in the same group of the one of the building material and the component.

13. The construction management system according to claim 1, further comprising a storage device storing information relating to a component constituting the building material, the building material being associated with information relating to the structure;
the processor is configured to manage the information relating to the component, and
wherein, in a case where the processor receives a change of one of the building material and the component, the processor causes a display in a manner different from a case where a change of one of the building material and the component is not received, with information indicating information relating to other building materials or components included in the same group of the one of the building material and the component.

14. The construction management system according to claim 1, wherein the processor causes, for each space of the building, output of information relating to the building material in association with the structure arranged in the space.

15. The construction management system according to claim 1, wherein the processor causes a collective output of information indicating the structure associated with the building material which is identified based on the management information, for each information relating to the building material.

16. A construction management method for managing a construction of a building, comprising:
a step of displaying information indicating information relating to a building material, for each structure, according to management information in which information relating to a structure constituting the building and information relating to a building material constituting the structure are associated with each other, in a construction management table; and
wherein, at the step of displaying information, in a case where a degree of detail of information relating to a constitution of the building material satisfies a predetermined condition, based on the management information, information which is different from a case where the predetermined condition is not satisfied, is displayed with information indicating a kind of the building material of the structure, in the construction management table.

17. A non-transitory computer-readable recording medium storing a program for causing a computer to execute each step of the construction management method according to claim 16 when executed by the computer.

18. The construction management system according to claim 1,
wherein a degree of detail of the information relating to the structure is a degree of detail of BIM data of the building,
wherein the predetermined condition is that the degree of detail of the information relating to the building material is higher than the degree of detail of the BIM data of the building,
and wherein, in a case where the degree of detail of the information relating to the building material is higher than the degree of detail of the BIM data of the building,
the processor causes the display of the information relating to the building material in a manner that differs from a case where the degree of detail of the information relating to the building material is not higher than the degree of detail of the BIM data of the building, in the construction management table.
